(19) United States
(12) Patent Application Publication
(10) Pub. No.: US 2026/0118226 A1
(43) Pub. Date: Apr. 30, 2026

(54) BATHTUB OVERFLOW TESTER

(71) Applicant: Scotty Bender, Imperial Beach, CA (US)

(72) Inventor: Scotty Bender, Imperial Beach, CA (US)

(21) Appl. No.: 18/927,824

(22) Filed: Oct. 25, 2024

(51) Int. Cl. G01M 99/00; E03C 1/24

(52) U.S. Cl. CPC G01M 99/008; E03C 1/24

(57) ABSTRACT

A removable miniature trough is disclosed that affixes to the bathtub wall at the overflow drain directly below the faucet, and forms a seal with the wall of the tub. To test the overflow drain, a user need only fill the trough, which holds a cup or two of water at most, rather than filling a tub that holds tens of liters. With the trough full, the overflow drain can be evaluated quickly and reliably. The trough has an open top and a planar side opening configured to bear against a wall of the bathtub, with a seal on side opening for forming a watertight seal between the trough and the bathtub wall. A beam extends from a distal wall of trough through the planar side opening and engages with an overflow drain plate to temporarily affix the removable trough to the bathtub wall below said faucet.

### BACKGROUND

This invention relates generally to plumbing aids, and more particularly to a device for testing a bathtub's overflow drain.

Modern bathtubs are equipped with an overflow drain that can direct water in a rising tub to a drainage line, and thereby prevent water from spilling over the tub wall and damaging the surrounding area. From time to time it is necessary for a plumber, technician, inspector, or home owner to check the overflow drain for leaks, clogs, seals, etc. To check this drain for leaks, blockages, etc., the plumber must fill the tub to the overflow drain's level, nearly filling the tube. Only then can the overflow drain's condition be evaluated. Once checked, the tub is emptied of the essentially full tub of water. This process is time consuming and wastes a great deal of water. If multiple checks are needed, this waste can be severe notwithstanding the time needed to fill the tub each time. The present invention addresses this problem.

### SUMMARY OF THE INVENTION

The present invention is a removable miniature trough that affixes to the bathtub wall at the overflow drain, directly below the faucet, and forms a seal with the wall of the tub. To test the overflow drain, a user need only fill the trough, which holds a cup or two of water at most, rather than filling a tub that holds tens of liters. With the trough full, the overflow drain can be evaluated quickly and reliably. Once the overflow drain is verified, the trough can be easily removed and reused again on another tub when needed.

These and other features of the invention will best be understood with reference to the accompanying drawings listed below, along with the detailed description of the invention below.

### BRIEF DESCRIPTION OF THE DRAWINGS

FIG. 1 is an elevated, perspective view of the embodiment engaged with a wall of a bathtub with the faucet on;

FIG. 2 is an elevated, perspective view of the embodiment separated from the wall of the bathtub;

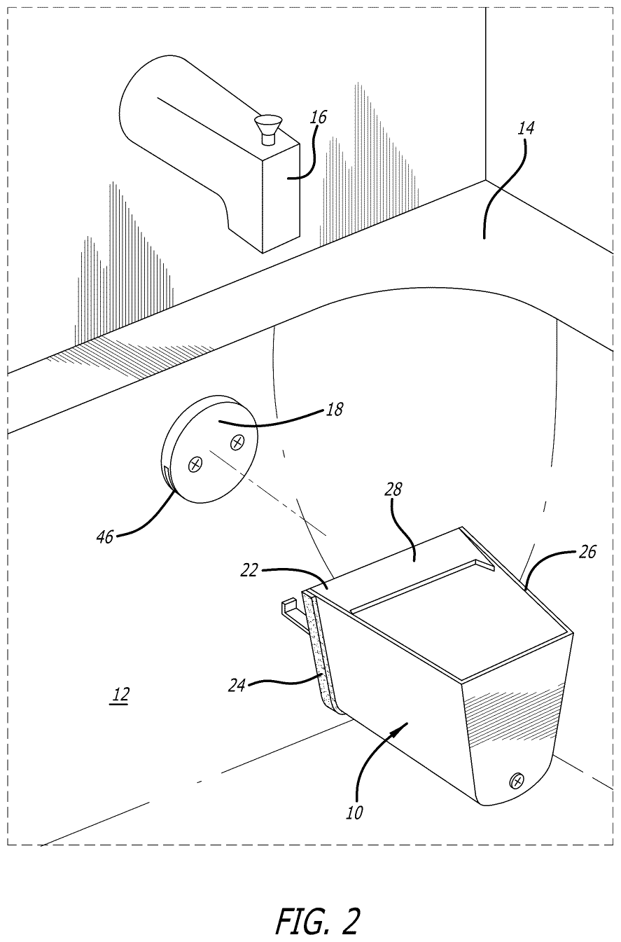

FIG. 3 is a side view, in cross section, of the embodiment; and

FIG. 4 is an enlarged, elevated, perspective view looking inwardly into the trough of the embodiment of FIG. 1.

### DETAILED DESCRIPTION OF THE PREFERRED EMBODIMENTS

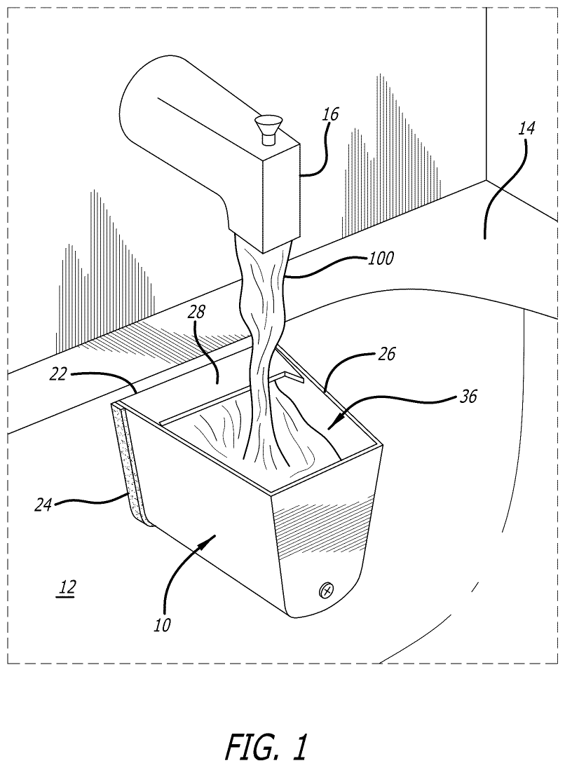

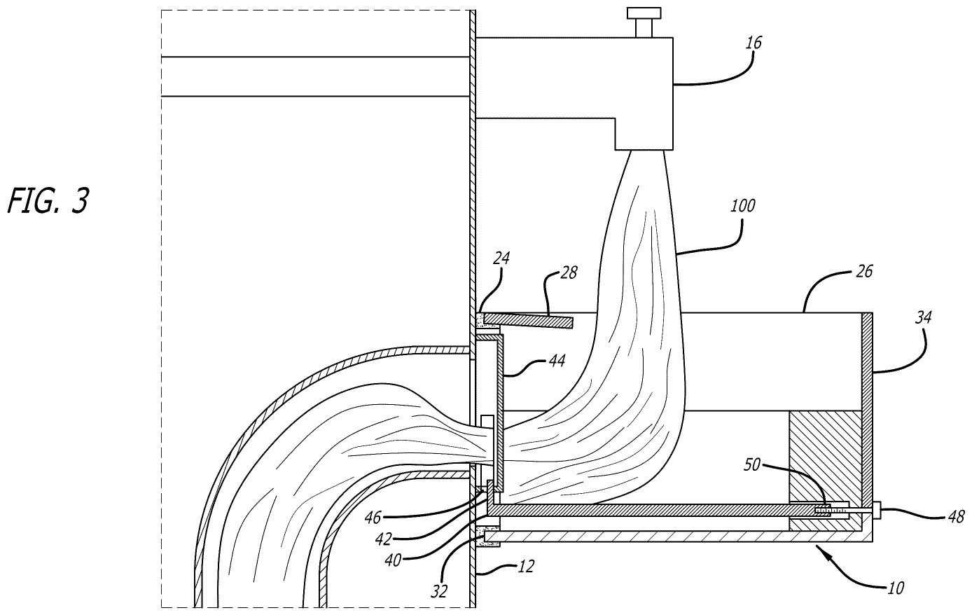

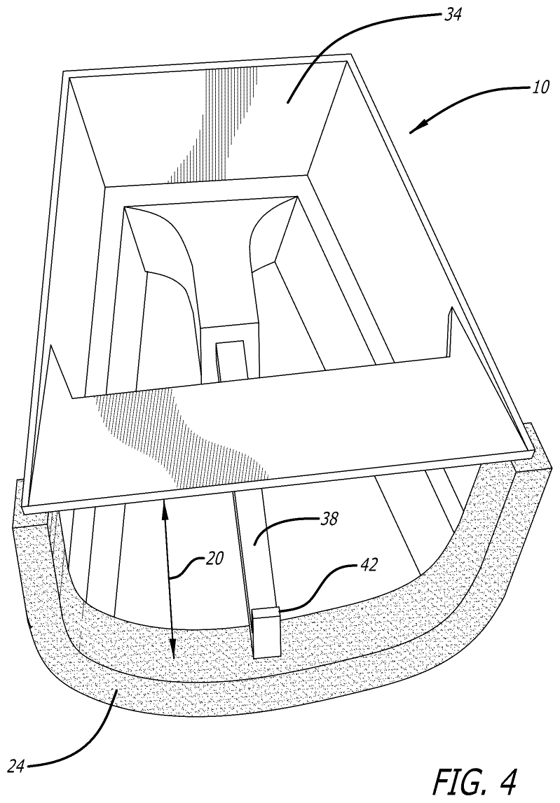

FIG. 1 illustrates a first preferred embodiment of the present invention in the form of a removable, temporary trough 10 that attaches to the wall 12 of a bathtub 14 below the faucet 16 and surrounds the overflow drain 18 for use in testing the overflow drain 18 for clogs and leaks. The trough 10 is preferably made of a lightweight, sturdy plastic that is molded into a unitary construction free of leaks and seams. There is a horseshoe shaped opening 20 (see FIG. 4) on a first side 22 of the trough 10 that is size to fit over a typical overflow drain 18, with a EPDM foam seal 24 that bears against the wall 12 of the tub 14. The top 26 is open (or substantially open in the case of embodiments that include an inclined deflection plate 28 to direct dribbling water into the trough) so as to receive water 100 directly from the tub faucet 16. The trough is otherwise sealed so that the water collected in the trough 10 will rise above the overflow drain 18 and fill the trough, allowing the user to see if the overflow drain 18 is properly functioning without filling the entire tub 14 (see FIG. 3). This device saves a tremendous amount of time since the trough 10 can fill in seconds and be removed easily, emptied, and refilled as many times as needed.

FIG. 4 shows the interior of the trough 10 from the horseshoe shaped opening 20. The seal 24 extends around the proximal edge 32 to prevent water from seeping out of the trough 10 at the edges. At the distal trapezoidal wall 34 of the trough's interior 36 is a beam 38 that extends to just beyond the plane defining the horseshoe shaped opening 20. The beam 38 includes at its free end 40 a vertical catch 42 that can be inserted into the overflow drain plate's lower opening 46 to fix the trough 10 on the wall 12 of the tub 14. The opposite end 50 of the beam can be attached to the fixed end via a fastener 48. The downward force of the trough's weight as it fills with water is counterbalanced by the force on the catch 42 by the overflow drain plate 44. Tilting the trough 10 upward releases the catch 42 and permits the device to be easily removed when the testing is complete.

Similarly, when applying the trough 10 to the drain plate 44, the device is tilted up so that the catch 42 on the beam 38 enters the drain plate opening 46, and then the trough is rotated to a level position with the open top 26 below the faucet 16. As long as the beam 38 and catch 42 are sufficiently sturdy, the trough 10 will remain in place without manual support so that the user can operate other tools. If the faucet 16 is turned on, water will collect in the trough and then enter the overflow drain 18. If the drain functions, a steady state condition may be reached with the quantity of water entering the trough and the quantity of water draining through the overflow drain are equal. If the water begins to overflow the trough, it may mean the overflow drain is clogged or not functioning correctly and additional investigation is required.

The invention does not leave any marks or scratches on the tub surface, is easily applied and removed, and can save tens of liters of water with each application. While the inventor's best mode of carrying out the invention is disclosed above, it is understood that a person of ordinary skill in the art would readily recognize various modifications and/or substitutions to the described and depicted embodiments without departing from the spirit of the invention. The scope of the invention is intended to include all such modifications and substitutions. Accordingly, the scope of the invention is properly determined by evaluating the appended claims using their ordinary meanings, consistent with but not limited by, the descriptions above and the accompanying figures.

I claim:

1. A removable fixture for a bathtub having a faucet, a drain, and an overflow drain, comprising:
a trough having a substantially open top and a planar side opening configured to bear against a wall of the bathtub;
a seal affixed to the planar side opening for forming a watertight seal between the trough and the bathtub wall;
an inclined plate adjacent the substantially open top above the planar side opening;
a beam extending from a distal wall of trough through the planar side opening, said beam further comprising a vertical catch; and
wherein said vertical catch is configured to engage with the overflow drain to temporarily affix the removable fixture to the bathtub wall below said faucet.

2. The removable fixture for a bathtub of claim 1, wherein the planar side opening is horseshoe shaped.

3. The removable fixture for a bathtub of claim 2, wherein the distal wall of the trough is trapezoidal.

4. The removable fixture for a bathtub of claim 3, wherein beam is attached to the distal wall via a fastener.

5. The removable fixture for a bathtub of claim 4, wherein the trough is affixed to the bathtub wall by rotating the catch into an opening in an overflow drain plate.
